(19) United States
(12) Patent Application Publication
(10) Pub. No.: US 2018/0285900 A1
(43) Pub. Date: Oct. 4, 2018

(54) METHOD AND SYSTEM FOR DETERMINING A PREDICTIVE MODEL FOR ESTIMATING TARGET OUTPUT FOR AN ENTERPRISE

(71) Applicant: WIPRO LIMITED, Bangalore (IN)

(72) Inventors: Soumendu BHATTACHARYYA, Kolkata (IN); Sandipan BHATTACHARYYA, Kolkata (IN)

(73) Assignee: WIPRO LIMITED

(21) Appl. No.: 15/471,266

(22) Filed: Mar. 28, 2017

(51) Int. Cl. G06Q 30/02; G06Q 10/06

(52) U.S. Cl. CPC G06Q 30/0202; G06Q 10/067

(57) ABSTRACT

The present disclosure relates to method and system for determining predictive model for estimating target output for enterprise by predictive model determination system. The predictive model determination system receives entity data from data sources, determine static variables from entity data based on pre-defined metadata and dynamic variables for pre-determined time frames based on pre-defined metadata and timing window, create data model based on relationship between static and dynamic variables, modify length of pre-determined time frames of dynamic variables based on change in historic values of corresponding dynamic variables, determine predicting variables by analysing static variables and dynamic variables of updated data model, form clusters of predicting variables based on common features of predicting variables, identify predictive models for each of clusters based on reupdated data model and determine predictive model from predictive models for each of clusters based on score assigned to each of clusters for estimating target output.

### FIELD OF INVENTION

The present subject matter is related in general to the field of prediction models, more particularly, but not exclusively to a method and system for determining a predictive model for estimating target output for an enterprise.

### BACKGROUND

Over past few years, there has been a steady rise in the importance of predictive analysis in organizations as varied as consumer goods companies, political consultancies, medical insurance, manufacturing, government and public sectors, banking and financial sectors and the like. Predictive analysis is the use of data, statistical algorithm and machine learning technique to identify the likelihood of future outcome based on historic data available. Even though predictive analytics has been around for decades, the technology is being discussed greatly and improvised in the present. More and more organizations are turning to predictive analytics, to increase their bottom line and competitive advantages. With ubiquity of easy-going software, predictive analytics is no longer just the domain of mathematicians and statisticians. Business analysts and line-of-business experts have also turned up to using these technologies.

Presently, there are many existing systems for predicting the target outcome for any organization or industry. Among these existing systems, most of the systems consider only one or two clusters of entity level data such as, customer level data and the like that leads to many errors in prediction. The data model generated or used in the past technology includes few static variables, targeting only specific or critical clusters and neglecting major part of other customer behaviour clusters. In most existing logical data models, clustering of customer related data happens initially and the data model is generated subsequently for the clustered customers. This causes many errors in prediction, when the predictive rules are applied.

In an example for predicting outcome in an enterprise using the existing technique, revenue generated by individual customers demonstrating diverse trend is considered. However, it is not possible to assess trend of every customer due to huge amount of information. Therefore, assessment of predicted revenue is done at an overall level leading to huge errors. Also, developing models for each segment is time consuming and costly. At times, after clustering, due to time and resource constraint, the model may be developed only for the bare minimum segments, leading to sub-optimum operation. Thus, existing systems fail to improve the accuracy of predictive models which consider heterogeneous entity clusters and dynamic time varying entity patterns.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method for determining a predictive model for estimating target output for an enterprise. The method comprises receiving a plurality of entity data from a plurality of data sources associated with an enterprise, determining a plurality of static variables from the plurality of entity data based on pre-defined metadata, computing a plurality of dynamic variables, for pre-determined time frames, from the plurality of entity data based on the pre-defined metadata and timing window data, creating a data model based on a relationship between the plurality of static variables and the plurality of dynamic variables, modifying length of the pre-determined time frames of each of the plurality of dynamic variables based on change in historic values of the corresponding plurality of dynamic variables. The data model is updated using the plurality of dynamic variables within the modified length of the pre-determined time frames. The method comprises determining one or more predicting variables by analysing the plurality of static variables and the plurality of dynamic variables of the updated data model, forming a plurality of clusters of predicting variables based on one or more common features of the one or more predicting variables. The data model is reupdated with a clustering schema identified from the one or more common features, identifying a plurality of predictive models for each of the plurality of clusters based on the reupdated data model and determining a predictive model from the plurality of predictive models for each of the plurality of clusters, based on a score assigned to each of the plurality of clusters, for estimating a target output.

In an embodiment, the present disclosure relates to a predictive model determination system for determining a predictive model for estimating target output for an enterprise. The predictive model determination system comprises a processor and a memory communicatively coupled to the processor, where the memory stores processor executable instructions, which, on execution, may cause the predictive model determination system to receive a plurality of entity data from a plurality of data sources associated with an enterprise, determine a plurality of static variables from the plurality of entity data based on pre-defined metadata, compute a plurality of dynamic variables, for pre-determined time frames, from the plurality of entity data based on the pre-defined metadata and timing window data, create a data model based on a relationship between the plurality of static variables and the plurality of dynamic variables, modify length of the pre-determined time frames of each of the plurality of dynamic variables based on change in historic values of the corresponding plurality of dynamic variables. The data model is updated using the plurality of dynamic variables within the modified length of the pre-determined time frames. The predictive model determination system determines one or more predicting variables by analysing the plurality of static variables and the plurality of dynamic variables of the updated data model, forms a plurality of clusters of predicting variables based on one or more common features of the one or more predicting variables. The data model is reupdated with a clustering schema identified from the one or more common features. The predictive model determination system identifies a plurality of predictive models for each of the plurality of clusters based on the reupdated data model and determines a predictive model from the plurality of predictive models for each of the plurality of clusters, based on a score assigned to each of the plurality of clusters, for estimating a target output.

In an embodiment, the present disclosure relates to a non-transitory computer readable medium including instructions stored thereon that when processed by at least one processor may cause a predictive model determination system to receive a plurality of entity data from a plurality of data sources associated with an enterprise, determine a plurality of static variables from the plurality of entity data based on pre-defined metadata, compute a plurality of dynamic variables, for pre-determined time frames, from the plurality of entity data based on the pre-defined metadata and timing window data, create a data model based on a relationship between the plurality of static variables and the plurality of dynamic variables, modify length of the pre-determined time frames of each of the plurality of dynamic variables based on change in historic values of the corresponding plurality of dynamic variables. The data model is updated using the plurality of dynamic variables within the modified length of the pre-determined time frames. The instruction causes the processor to determine one or more predicting variables by analysing the plurality of static variables and the plurality of dynamic variables of the updated data model, forms a plurality of clusters of predicting variables based on one or more common features of the one or more predicting variables. The data model is reupdated with a clustering schema identified from the one or more common features. The instruction causes the processor to identify a plurality of predictive models for each of the plurality of clusters based on the reupdated data model and determines a predictive model from the plurality of predictive models for each of the plurality of clusters, based on a score assigned to each of the plurality of clusters, for estimating a target output.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for determining a predictive model for estimating target output for an enterprise in accordance with some embodiments of the present disclosure;

FIG. 2 shows a detailed block diagram of a predictive model determination system in accordance with some embodiments of the present disclosure;

FIG. 3 shows an exemplary representation of determining a predictive model for estimating target output for a banking enterprise in accordance with some embodiments of the present disclosure;

FIG. 4 illustrates a flowchart showing a method for determining a predictive model for estimating target output for an enterprise in accordance with some embodiments of present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to a method and a predictive model determination system for determining a predictive model for estimating target output for an enterprise. In an embodiment, the enterprise may include banking enterprise, manufacturing enterprise, customer related product and service enterprise and the like. The predictive model determination system may receive a plurality of entity data from the plurality of data sources associated with the enterprise. In an embodiment, the data sources associated with the enterprise may include data marts, data operation sources and the like where the data associated with customers and organization may be stored. In an embodiment, the entity may include customers and the like. A person skilled in the art would understand that any other entity associated with organization which are not mentioned explicitly may also be used in the present disclosure. The predictive model determination system determines a plurality of static and dynamic variables from the plurality of entity data and creates a data model encompassing the determined variables. The data model may be created based on the relationship between the plurality of static variables and the plurality of dynamic variables. The plurality of dynamic variables may be determined for a pre-determined time frame. The pre-determined time frame for the plurality of dynamic variables may be modified based on change in historic values of corresponding plurality of dynamic variables and the data model may be updated with the modification details. Once the data model is updated, one or more predicting variables having a relatively higher contribution to target outcome may be determined based on the plurality of static variables and the plurality of dynamic variables from the updated data model. After determining the one or more predicting variables, common features of the predicting variables may be analysed for forming plurality of clusters. The plurality of clusters includes one or more predicting variables with common features. The predictive model determination system determines a predictive model from a plurality of predictive models for each of the plurality of clusters. The predictive model may be determined based on a score assigned to each plurality of cluster. In an embodiment, statistical technique may be used for determining predictive model for each cluster. The predictive model determined for each cluster helps in estimating the target outcome. Thus, the present disclosure leads to better precision and shorter turn-around time in predicting target outcome without compromising on the statistical quality.

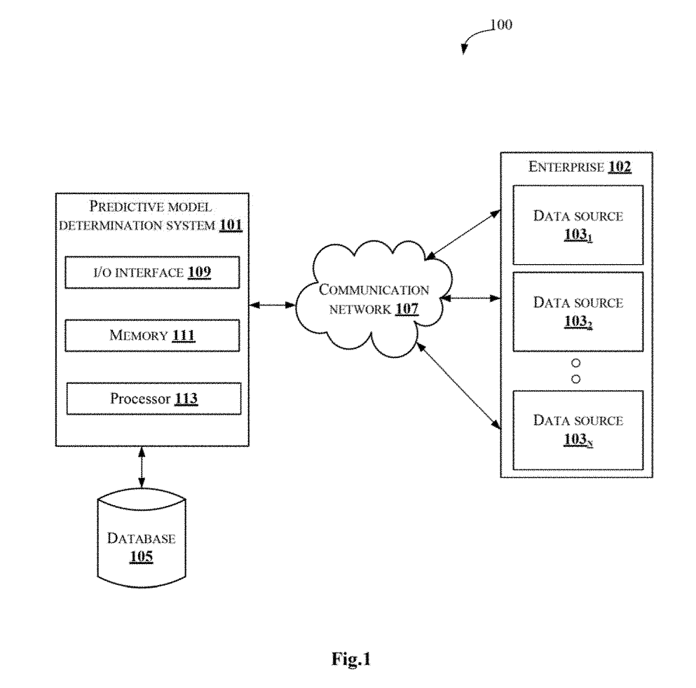

FIG. 1 illustrates an exemplary environment for determining a predictive model for estimating target output for an enterprise in accordance with some embodiments of the present disclosure.

As shown in FIG. 1, the environment 100 includes a predictive model determination system 101 connected through a communication network 107 to a data source 103₁, a data source 103₂ . . . and a data source 103_{N} of an enterprise 102 (collectively referred as plurality of data sources 103). The communication network 107 may include, but is not limited to, a direct interconnection, an e-commerce network, a Peer to Peer (P2P) network, Local Area Network (LAN), Wide Area Network (WAN), wireless network (e.g., using Wireless Application Protocol), Internet, Wi-Fi and the like. In an embodiment, the enterprise may include, but is not limited to, banking enterprise, health monitoring and insurance systems, public and private enterprise and the like. A person skilled in the art would understand that any other enterprise, not mentioned explicitly, may also be included in the present disclosure. In an embodiment, the plurality of data sources 103 may include databases, data mart, operation data sources for storing information associated with customers and plurality of data operational stores for providing details associated with the enterprise 102. Further, the predictive model determination system 101 may be connected to a database 105. The predictive model determination system 101 determines predictive model for the enterprise 102 for estimating the target outcome of the enterprise 102. In an embodiment, the predictive model determination system 101 may include, but is not limited to, a laptop, a desktop computer, a Personal Digital Assistant (PDA), a notebook, a smartphone, a tablet and any other computing devices.

Initially, when the enterprise 102 requests for estimating the target output, the predictive model determination system 101 may receive a plurality of entity data from the plurality of data sources 103 of the enterprise 102. In an embodiment, the plurality of entity data may comprise customer related information, organization related information, transaction information associated with customers, product and service related data, campaign related data, point of sale data and the like. A person skilled in the art would understand that the entity data may also include any other data not mentioned explicitly in the present disclosure. The predictive model determination system 101 determines the plurality of static variables from the received plurality of entity data based on a pre-defined metadata stored in the database 105. For example, the static data associated with the banking enterprise may include account information such as, date of birth, gender, educational information, marital status and the like of the customers which may hardly change over time. In addition to static variables, the plurality of dynamic variables may be computed from the plurality of entity data based on the pro-defined metadata and timing window data. In an embodiment, the plurality of dynamic variables may help in identifying hidden patterns in customers behaviour. In an embodiment, the timing window may include daily, weekly, fortnightly, monthly, quarterly, half yearly, annual and the like. The plurality of dynamic variables may be computed for pre-determined time frames. For example, the dynamic variables associated with the banking enterprise may include, transaction related information and statement related information such as, credit lines, total transactions, balances, payment amounts and the like in the corresponding time frame. The predictive model determination system 101 may determine the relationship between the plurality of static variables and the plurality of dynamic variables and may create a data model based on the relationship. In an embodiment, the relationship may be identified using a pre-stored relationship rule in the database 105. Further, the predictive model determination system 101 may modify length of the pre-determined time frames of the plurality of dynamic variables based on a change in the historic values of corresponding dynamic variables. The data model may be updated with the plurality of dynamic variables within the modified length of the pre-determined time frames. Once the data model is updated, the predictive model determination system 101 may analyse the plurality of static variables and the plurality of dynamic variables of the updated data model to determine one or more predicting variables. In a non-limiting embodiment, the one or more predicting variables may be determined using regression technique, computation of Information Value, correlation matrix, Chi Square and the like. A person skilled in the art would understand that any other technique for determining the predicting variables may be used in the present disclosure. In an embodiment, the predicting variables may be the variables having a relatively higher contribution with the target outcome. After identifying the one or more predicting variables, the predictive model determination system 101 may form a plurality of clusters based on common features of the one or more predicting variables. After forming the plurality of clusters, the data model may be reupdated with a clustering schema which may be identified from the one or more common features. In an embodiment, the plurality of clusters may be formed using segmentation technique. A person skilled in the art would understand that any other technique for forming the clusters may also be used in the present disclosure. Based on the reupdated data model, the predictive model determination system 101 may identify the plurality of predictive models for the plurality of clusters. On identification of the plurality of predictive models, the predictive model determination system 101 determines one predictive model for each of the plurality of clusters based on the score assigned to each of the clusters. In an embodiment, the predictive model may be selected for each of the plurality of clusters based on statistical measurements. The predictive model determined may be used for estimating the target outcome of the enterprise 102.

The predictive model determination system 101 includes an I/O Interface 109, a memory 111 and a processor 113. The I/O interface 109 may be configured to receive entity data from the plurality of data sources 103.

The received information from the I/O interfaces 109 may be stored in the memory 111. The memory 111 is communicatively coupled to the processors 113 of the predictive model determination system 101. The memory 111 may also store processor instructions which may cause the processors 113 to execute the instructions for determining predictive model for estimating the target outcome for the enterprise 102.

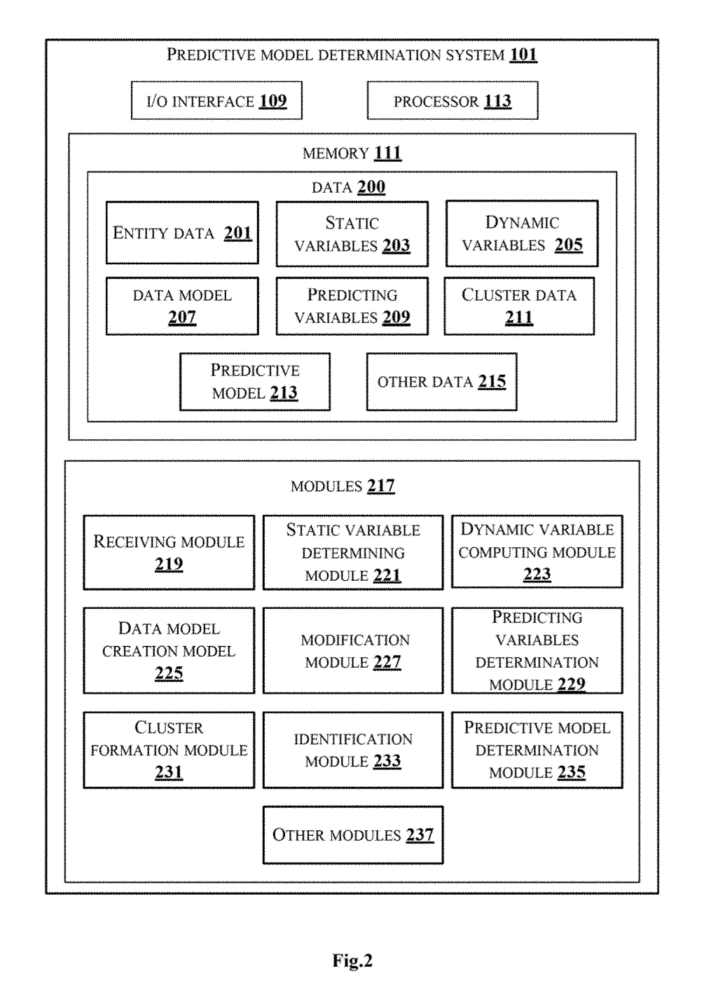

FIG. 2 shows a detailed block diagram of a predictive model determination system in accordance with some embodiments of the present disclosure.

Data 200 and one or more modules 217 of the predictive model determination system 101 are described herein in detail. In an embodiment, the data 200 includes entity data 201, static variables 203, dynamic variables 205, data model 207, predicting variables 209, cluster data 211, predictive model 213 and other data 215.

The entity data 201 may include details about the enterprise 102 and customers associated with the enterprise 102. The details may include customer related information, organization related information, transaction information associated with customer, product and service related data, campaign related data, point of sale data and the like. For example, consider the enterprise 102 is a bank. Banks contain a database which consists of different tables, like account information, transaction information, statement information and the like. Account information might contain variables like date of birth, gender, educational information, marital status and the like of the customers. Transactional information may include each transaction detail of the customer within a time frame and statement information may include credit lines, total transactions, balances, payment amounts in that time frame and the like.

The static variables 203 may be derived from the plurality of entity data 201. The static variables 203 may be the variables which may not change frequently over a period. In an embodiment, the static variables 203 may be determined using the pre-defined metadata which may be received from the database 105.

The dynamic variables 205 may be computed from the plurality of entity data 201. The dynamic variables 205 may be computed for the pre-determined time frames. In an embodiment, different time frames may include daily, weekly, fortnightly, monthly, quarterly, half yearly, annual and the like. In an embodiment, dynamic variables 205 may help in identifying hidden patterns in customers behaviour. In an embodiment, the dynamic variables 205 may be computed using the pre-defined metadata and the timing window data.

The data model 207 may include the plurality of static variables 203 and the plurality of dynamic variables 205. The data model 207 may be created based on the relationship between the static variables 203 and the dynamic variables 205. In an embodiment, the data model 207 may also include modified length of pre-determined time frames along with the dynamic variables 205 within that time frame. Further, the data model 207 may also be re-updated with the clustering schema.

The predicting variables 209 may include variables which may have a higher contribution in predictive the target outcome. The predicting variables 209 may be determined from the plurality of static variables 203 and the plurality of dynamic variables 205 of updated data model 207. In an embodiment, the predicting variables 209 may be identified by analysing the static and the dynamic variables 205 using the regression technique.

The cluster data 211 may include details about the plurality of clusters formed from predicting variables 209. The plurality of clusters may be formed based on common features of the one or more predicting variables 209. In an embodiment, the plurality of clusters may be formed using segmentation technique. The cluster data 211 may also include the score assigned to each of the plurality of clusters.

The predictive model 213 may include details about the plurality of predictive models identified for each of the plurality of clusters. The plurality of predictive models of each of the plurality of clusters may be identified based on the reupdated data model 207. Further, the predictive model 213 may also include the predictive model 213 determined for each of the plurality of clusters. The predictive model 213 for each of the plurality of clusters may be determined based on the score assigned to the plurality of clusters.

The other data 215 may store data, including temporary data and temporary files, generated by modules for performing the various functions of the predictive model determination system 101.

In an embodiment, the data 200 in the memory 111 are processed by the one or more modules 217 of the predictive model determination system 101. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The said modules 217 when configured with the functionality defined in the present disclosure will result in a novel hardware.

In one implementation, the one or more modules 217 may include, but are not limited to, a receiving module 219, a static variable determining module 221, a dynamic variable computing module 223, a data model creation module 225, a modification module 227, a predicting variables determination module 229, a cluster formation module 231, an identification module 233 and a predictive model determination module 235. The one or more modules 217 may also comprise other modules 237 to perform various miscellaneous functionalities of the predictive model determination system 101. It will be appreciated that such modules 217 may be represented as a single module or a combination of different modules 217.

The receiving module 219 may receive the plurality of entity data 201 from the plurality of data sources 103 of the enterprise 102. The plurality of entity data 201 may include customer related information, organization related information, transaction information associated with customers, product and service related data, campaign related data point of sale data and the like. In an embodiment, the entity data 201 may vary based on the type of the enterprise 102. Further, the receiving module 219 may also receive the pre-defined metadata details and the timing window data from the database 105.

The static variable determining module 221 may determine the plurality of static variables 203 from the plurality of entity data 201. The static variable determining module 221 may determine those variables which may not change frequently over time. The static variable determining module 221 may use the pre-defined metadata for determining the plurality of static variables 203. For example, in banking enterprise, static variables 203 may include account information such as, date of birth, gender, educational information, marital status and the like of customers which may not change much over time.

The dynamic variable computing module 223 may compute the plurality of dynamic variables 205 from the plurality of entity data 201. The dynamic variables computing module 223 may compute the plurality of dynamic variables 205 for the pre-determined time frames. In an embodiment, the dynamic variable computing module 223 may use the pre-defined metadata and the timing window data for determining the plurality of dynamic variables 205. For example, in banking enterprise, dynamic variables 205 may include transaction related variables, which may include transaction details of the customer within a time frame and the statement related variables, which may include credit lines, total transactions, balances, payment amounts and the like in that time frame.

The data model creation module 225 may create the data model 207 by identifying the relationship between the plurality of static variables 203 and the plurality of dynamic variables 205. In an embodiment, the relationship may be identified based on the pre-stored relationship rule. In an embodiment, the data model creation module 225 may use data modelling for creating the data model 207.

The modification module 227 may modify the length of the pre-determined time frames of each of the plurality of dynamic variables 205. The modification module 227 may modify the length based on change in the historic values of the corresponding plurality of dynamic variables 205. In an embodiment, the modification module 227 may modify the length of the pre-determined time frames based on statistical analysis on historical fluctuation of each dynamic variables 205. In another embodiment, the modification module 227 may modify the length of the pre-determined time frames by using machine learning to determine most optimum time frame for each of the plurality of dynamic variable 205. In one example, if a delta change value between a previous value of the time frame and a current value of the time frame is higher than an upper threshold, then the length of next consecutive time frame may be extended, which in turn may reduce updating frequency of the data model 207. In another example, if the delta change value between the previous value of the time frame and the current value of the time frame is lower than a minimum threshold range, then the length of next consecutive time frame may be shortened, which in turn may increase updating frequency of the data model 207. Further, based on the modification, the modification module 227 may update the data model 207 with the plurality of dynamic variables 205 within the modified time frames. In an embodiment, updating the data model 207 may result in capture of more details, elaborate and sets of dynamic variables 205. This makes the data model 207 dynamic enough to capture even the smallest changes in the plurality of entity data 201. By capturing smallest changes in the plurality of entity data 201, various features which may affect the target outcome may be captured.

The predicting variables determination module 229 may determine the one or more predicting variables 209. The predicting variables determination module 229 analyses the plurality of static variables 203 and the plurality of dynamic variables 205 from the updated data model 207. In an embodiment, the predicting variables determination module 229 may use the regression technique to determine the one or more predicting variables 209. In an embodiment, the one or more predicting variables 209 may be determined based on a weightage of each of the plurality of static variables 203 and the plurality of dynamic variables 205 in predicting the target outcome. In an embodiment, different types of regression models may be used such as, Ordinary Least Square (OLS), Generalized Linear Model (GLM) and the like. A person skilled in the art would understand that any other regression technique not mentioned explicitly may also be used in the present disclosure. In another embodiment, the regression technique may use a statistical method such as, Weight of Evidence (WOE), information value and the like. A person skilled in the art would understand that any other statistical method, not mentioned explicitly may also be used in the present disclosure. In an embodiment, if the plurality of static and dynamic variables is collinear, then the variables with lower variance inflation factor may be removed or may be not considered. In case, the plurality of static and the dynamic variables are not removed, then the impact of such variables may be diluted and the variables appear insignificant even if they may be significant.

The cluster formation module 231 may form the plurality of clusters of the predicting variables 209. The cluster formation module 231 may form the plurality of clusters based on the common features of the one or more predicting variables 209. In an embodiment, the cluster formation module 231 may use segmentation technique for forming the plurality of clusters. The plurality of clusters may include one or more predicting variables 209 having common features such as, patterns, attributes and value ranges. Further, based on the formation of plurality of clusters, the cluster formation module 231 may identify the clustering schema from the common features of the predicting variables 209 and reupdate the data model 207. In an embodiment, the cluster formation module 231 may use Chi Square Automated Interaction Detector (CSIA) for segmentation. This may create values or feature or value ranges or derivation from one or more predicting variables 209 for segmentation. The rules for these values indicating segments may be infused back to create clusters.

The identification module 233 may identify the plurality of predictive models for each of the plurality of clusters. The plurality of predictive models may be identified based on the reupdated data model 207. In an embodiment, the identification module 233 may analyse statistical trends, patterns and regression models specific to each of the plurality of clusters to identify multiple predictive model 213 specific to each cluster.

The predictive model determination module 235 may determine the predictive model from the plurality of predictive models for each of the plurality of clusters. The predictive model determination module 235 may determine the predictive model 213 based on the score which may be assigned to the plurality of clusters. The predictive model 213 determined for each of the plurality of clusters helps in estimating the target output. In an embodiment, the predictive model determination module 235 may determine the most optimum predictive model 213 among the plurality of predictive models specific to each cluster based on measuring the goodness of fit for each predictive model 213. In an embodiment, the score may be defined as the goodness of the fit. In an embodiment, the score assigned to the plurality of clusters may be assigned by computing the discrepancy between observed outcome and the predicted outcome expected under the predictive model 213.

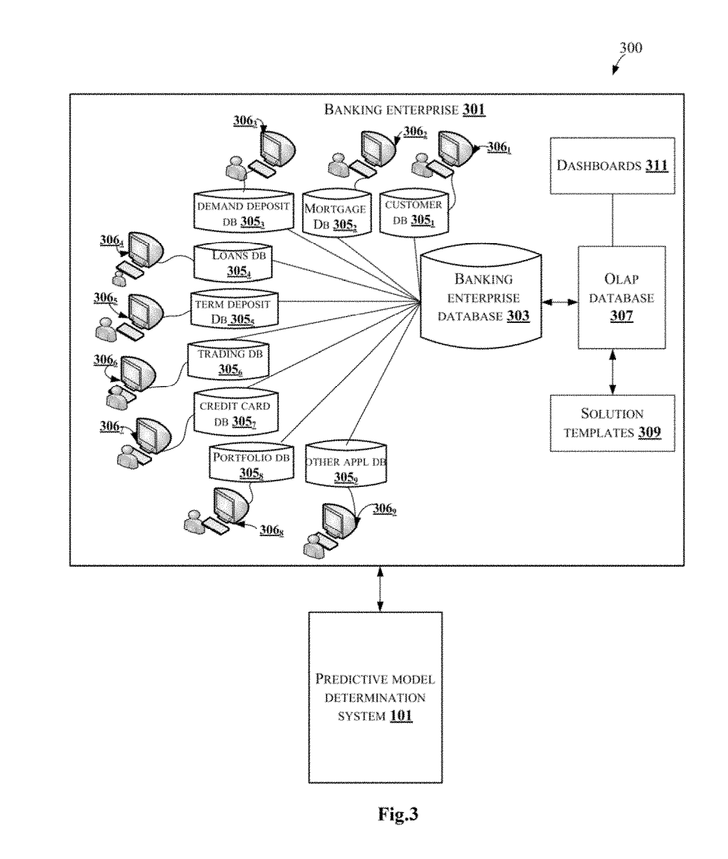

FIG. 3 shows an exemplary representation of determining a predictive model for estimating target output for a banking enterprise in accordance with some embodiments of the present disclosure.

As shown in FIG. 3, the environment 300 illustrates a scenario of determining a predictive model for estimating the target outcome for the banking enterprise in an exemplary embodiment of the present disclosure. The environment 300 illustrates the predictive model determination system 101 connected to the banking enterprise 301. In an embodiment, the predictive model determination system 101 may be connected through the communication network (not shown in FIG. 3) to the banking enterprise 301. A person skilled in the art would understand that FIG. 3 is an exemplary embodiment and the enterprise may also include any other enterprises. The banking enterprise 301 includes a banking enterprise database 303 which may include complete details associated with the bank. The banking enterprise database 303 may receive updates from a plurality of application databases (DB). As shown in FIG. 3, the plurality of application databases may include customer database (DB) 305₁, mortgage database (DB) 305₂, demand deposit database (DB) 305₃, loans database (DB) 305₄, term deposit database (DB) 305₅, trading database (DB) 305₆, credit card database (DB) 305₇, portfolio database (DB) 305₈ and other application database (DB) 305₉. A person skilled in the art would understand that the banking enterprise 301 may also comprise any other databases. Each of the application databases may be connected to a computing device 306₁, . . . computing device 306₉ as shown in FIG. 3, where a user working on the corresponding application of the bank may update data into the application databases. Further, the banking enterprise 301 includes other components such as, an Online Analytical Processing (OLAP) database 307 connected to the banking enterprise database 303. The OLAP database 307 may be connected to a dashboard 311 of the banking enterprise 301 comprising user interface and to a solution templates 309 which may comprise different banking solutions. Initially, the predictive model determination system 101 may receive the plurality of entity data 201 from the plurality of application databases. In an embodiment, the plurality of application databases may be connected to the predictive model determination system 101 (not shown explicitly in fig). For example, the predictive model determination system 101 receives account information, transaction information, statement information from the plurality of application database. For instance, account information may contain variables like date of birth, gender, educational information, marital status and the like of the customers of the bank. The transactional information may contain transaction details of the customer along with a time frame and the statement information may contain credit lines, total transactions, balances, payment amounts associated with the customers of the bank. The predictive model determination system 101 uses the database (not shown in FIG. 3) comprising the pre-stored metadata for determining static variables 203 from the above-mentioned variables and dynamic variables 205. For example, transaction and statement information creates different dynamic variables 205 after aggregating data at different levels such as, daily, weekly, fortnightly, monthly, quarterly, half yearly, annual and the like. The predictive model determination system 101 analyses the relationship between the static variables 203 which are account information such as, customer information and dynamic variables 205 such as, transaction and statement related information of the customer. The static variables 203 and dynamic variables 205 having a common relationship may be combined and the data model 207 may be formed. Further, the predictive model determination system 101 may modify the length of the time frame for the dynamic variables 205 based on the historic values of corresponding dynamic variables 205. The predictive model determination system 101 determines plurality of clusters of one or more predicting variables 209, based on common features of the predicting variables 209. Further, the plurality of predictive models may be identified for each of the plurality of clusters. The predictive model determination system 101 determines the predictive model for each cluster associated with the banking enterprise 301 which may help in estimating the target outcome of the banking enterprise 301.

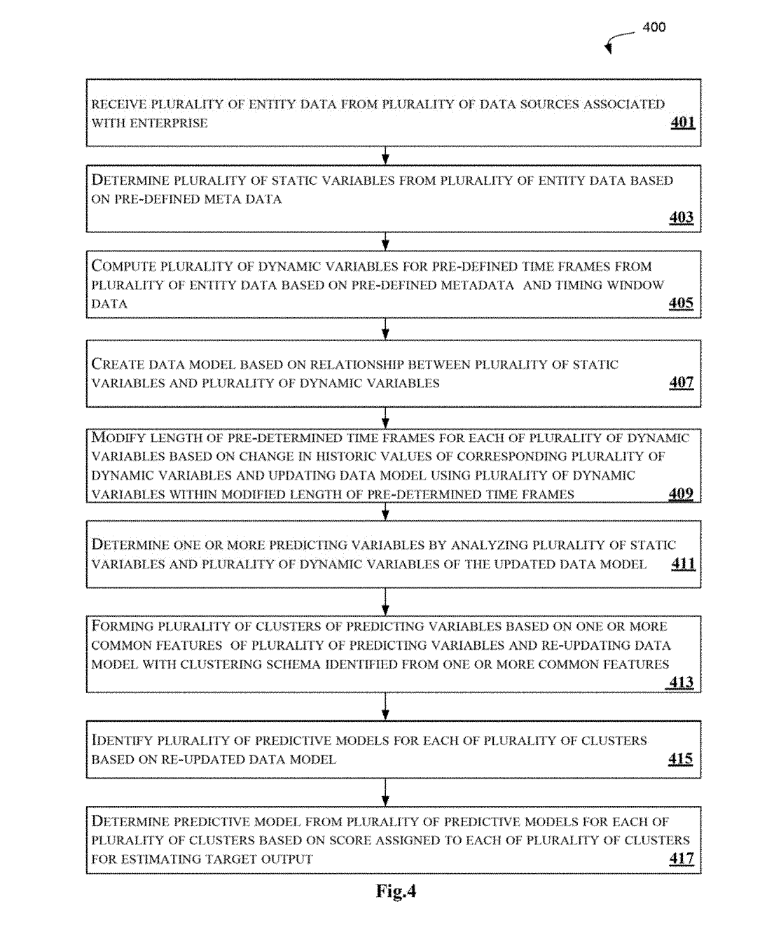

FIG. 4 illustrates a flowchart showing a method for determining a predictive model for estimating target output for an enterprise in accordance with some embodiments of present disclosure.

As illustrated in FIG. 4, the method 400 includes one or more blocks for determining a predictive model for estimating target output for an enterprise 102. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, receiving, by the receiving module 219, the plurality of entity data 201 from the plurality of data sources 103 associated with the enterprise 102.

At block 403, determining, by the static variable determining module 221, the plurality of static variables 203 from the plurality of entity data 201 based on the pre-defined metadata.

At block 405, computing, by the dynamic variable computing module 223, the plurality of dynamic variables 205, for the pre-determined time frames from the plurality of entity data 201 based on the pre-defined metadata and the timing window data.

At block 407, creating, by the data model creation module 225, the data model 207 based on the relationship between the plurality of static variables 203 and the plurality of dynamic variables 205.

At block 409, modifying, by the modification module 227, the length of the pre-determined time frames of each of the plurality of dynamic variables 205 based on the change in historic values of the corresponding plurality of dynamic variables 205. The data model 207 is updated using the plurality of dynamic variables 205 within the modified length of the pre-determined time frames.

At block 411, determining, by the predicting variables determination module 229, the one or more predicting variables 209 by analysing the plurality of static variables 203 and the plurality of dynamic variables 205 of the updated data model 207.

At block 413, forming, by the cluster formation module 231, the plurality of clusters of the predicting variables 209 based on the one or more common features of the plurality of predicting variables 209. The data model 207 is reupdated with a clustering schema identified from the one or more common features.

At block 415, identifying, by the identification module 233, the plurality of predictive models for each of the plurality of clusters based on the reupdated data model 207.

At block 417, determining, by the predictive model determination module 235, the predictive model 213 from the plurality of predictive models for each of the plurality of clusters, based on the score assigned to each of the plurality of clusters for estimating a target output.

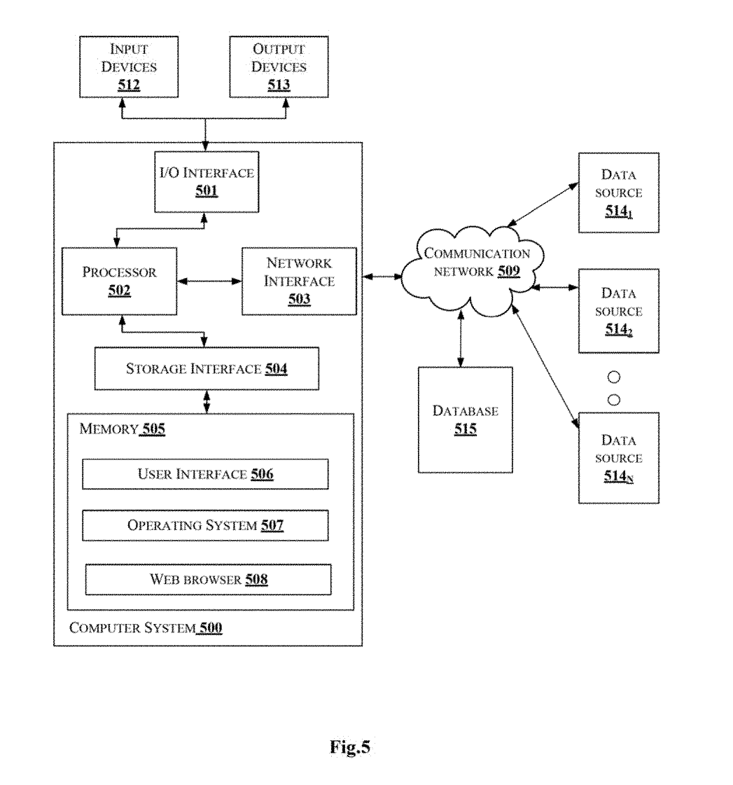

FIG. 5 illustrates a block diagram of an exemplary computer system 500 for implementing embodiments consistent with the present disclosure. In an embodiment, the computer system 500 is used to implement the predictive model determination system 101. The computer system 500 may comprise a central processing unit (“CPU” or “processor”) 502. The processor 502 may comprise at least one data processor for determining a predictive model for estimating target outcome for an enterprise 102. The processor 502 may include specialized processing units such as, integrated system (bus) controllers, memory management control units, floating point units, graphics processing units, digital signal processing units, etc.

The processor 502 may be disposed in communication with one or more input/output (I/O) devices (not shown) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (OSM), long-term evolution (LTE), WiMax, or the like), etc.

Using the I/O interface 501, the computer system 500 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 consists of a predictive model determination system 101. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with a data source 514₁, a data source 514₂, . . . a data source 514_{N} (collectively referred as plurality of data sources 514) and a database 515. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 509 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data 506, such as, the data, variables, records, etc., as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8. etc.), Apple iOS, Google Android, Blackberry OS, or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

The present disclosure helps in estimating target outcome for an enterprise by determining an optimized predictive model.

An embodiment of the present disclosure provides enhanced accuracy since no manual intervention is required needed to create the data model.

An embodiment of the present disclosure provides better precision and shorter turn-around time in predicting the target outcome without compromising on the statistical quality.

The present disclosure reduces overall time and cost for determining predictive models for enterprises.

In an embodiment of the present disclosure, updating the logical data model with modified time frames results in capture of more detail, elaborate and set of dynamic variables which makes the data model dynamic enough to capture all the smallest changes in entity pattern. Capturing smallest changes in entity patterns and various features help in optimizing the predictive model.

An embodiment of the present disclosure maintains the heterogeneity of the entity clusters while developing the predictive solution like a homogenous cluster.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Environment |
| 101 | Predictive model determination system |
| 102 | Enterprise |
| 103 | Plurality of data sources |
| 105 | Database |
| 107 | Communication network |
| 109 | I/O interface |
| 111 | Memory |
| 113 | Processor |
| 200 | Data |
| 201 | Entity data |
| 203 | Static variables |
| 205 | Dynamic variables |
| 207 | Data model |
| 209 | Predictive variables |
| 211 | Cluster data |
| 213 | Predictive model |
| 215 | Other data |
| 217 | Modules |
| 219 | Receiving module |
| 221 | Static variable determining module |
| 223 | Dynamic variable determining module |
| 225 | Data model creation module |
| 227 | Modification module |
| 229 | Predicting variables determination module |
| 231 | Cluster formation module |
| 233 | Identification module |
| 235 | Predictive model determination module |
| 237 | Other modules |

What is claimed is:

1. A method for determining a predictive model for estimating target output for an enterprise, the method comprising:
receiving, by a predictive model determination system (101), a plurality of entity data (201) from a plurality of data sources (103) associated with an enterprise (102);
determining, by the predictive model determination system (101), a plurality of static variables (203) from the plurality of entity data (201) based on pre-defined metadata;
computing, by the predictive model determination system (101), a plurality of dynamic variables (205), for pre-determined time frames, from the plurality of entity data (201) based on the pre-defined metadata and timing window data;
creating, by the predictive model determination system (101), a data model (207) based on a relationship between the plurality of static variables (203) and the plurality of dynamic variables (205);
modifying, by the predictive model determination system (101), length of the pre-determined time frames of each of the plurality of dynamic variables (205) based on change in historic values of the corresponding plurality of dynamic variables (205), wherein the data model (207) is updated using the plurality of dynamic variables (205) within the modified length of the pre-determined time frames;
determining, by the predictive model determination system (101), one or more predicting variables (209) by analysing the plurality of static variables (203) and the plurality of dynamic variables (205) of the updated data model (207);
forming, by the predictive model determination system (101), a plurality of clusters of predicting variables (209) based on one or more common features of the plurality of predicting variables (209), wherein the data model (207) is reupdated with a clustering schema identified from the one or more common features;
identifying, by the predictive model determination system (101), a plurality of predictive models for each of the plurality of clusters based on the reupdated data model (207); and
determining, by predictive model determination system (101), a predictive model (213) from the plurality of predictive models for each of the plurality of clusters, based on a score assigned to each of the plurality of clusters, for estimating a target output.

2. The method as claimed in claim 1, wherein the plurality of entity data (201) comprises customer related information, organization related information, product related data, campaign related data, Point of Sale (POS) data and transaction information associated with customers.

3. The method as claimed in claim 1, wherein the relationship between the static and dynamic variables is determined based on a pre-stored relationship rule.

4. The method as claimed in claim 1, wherein the plurality of predicting variables (209) are identified using regression technique.

5. The method as claimed in claim 1, wherein the one or more common features of the plurality of predicting variables (209) comprises patterns, attributes and value range.

6. The method as claimed in claim 1, wherein the score to the plurality of clusters is assigned by computing a discrepancy between an observed target outcome and a predicted outcome of the predictive model (213).

7. The method as claimed in claim 1, wherein the predictive model (213) for each of the plurality of clusters is determined based on statistical measurements.

8. The method as claimed in claimed 1, wherein the plurality of clusters is determined using segmentation technique.

9. A predictive model determination system (101) for estimating target output for an enterprise (102), comprising:
a processor (113); and
a memory (l 1) communicatively coupled to the processor (113), wherein the memory (111) stores processor instructions, which, on execution, causes the processor (113) to:
receive a plurality of entity data (201) from a plurality of data sources (103) associated with an enterprise (102);
determine a plurality of static variables (203) from the plurality of entity data (201) based on pre-defined metadata;
compute a plurality of dynamic variables (205), for pre-determined time frames, from the plurality of entity data (201) based on the pre-defined metadata and timing window data;
create a data model (207) based on a relationship between the plurality of static variables (203) and the plurality of dynamic variables (205);
modify length of the pre-determined time frames of each of the plurality of dynamic variables (205) based on change in historic values of the corresponding plurality of dynamic variables (205), wherein the data model (207) is updated using the plurality of dynamic variables (205) within the modified length of the pre-determined time frames;
determine one or more predicting variables (209) by analysing the plurality of static variables (203) and the plurality of dynamic variables (205) of the updated data model (207);
form a plurality of clusters of predicting variables (209) based on one or more common features of the plurality of predicting variables (209), wherein the data model (207) is reupdated with a clustering schema identified from the one or more common features;
identify a plurality of predictive models for each of the plurality of clusters based on the reupdated data model (207); and
determine a predictive model (213) from the plurality of predictive models for each of the plurality of clusters, based on a score assigned to each of the plurality of clusters, for estimating a target output.

10. The predictive model determination system (101) as claimed in claim 9, wherein the plurality of entity data (201) comprises customer related information, organization related information, product related data, campaign related data, Point of Sale (POS) data and transaction information associated with customers.

11. The predictive model determination system (101) as claimed in claim 9, wherein the processor (113) determines the relationship between the static and dynamic variables based on pre-stored relationship rule.

12. The predictive model determination system (101) as claimed in claim 9, wherein the processor (113) identifies the plurality of predicting variables (209) using regression technique.

13. The predictive model determination system (101) as claimed in claim 9, wherein the one or more common features of the plurality of predicting variables (209) comprises patterns, attributes and value range.

14. The predictive model determination system (101) as claimed in claim 9, wherein the processor (113) assigns the score to the plurality of clusters by computing a discrepancy between an observed target outcome and a predicted outcome of the predictive model (213).

15. The predictive model determination system (101) as claimed in claim 9, wherein the processor (113) determines the predictive model (213) for each of the plurality of clusters based on statistical measurements.

16. The predictive model determination system (101) as claimed in claimed 9, wherein the processor (113) determines the plurality of clusters using segmentation technique.

17. A non-transitory computer readable medium including instruction stored thereon that when processed by at least one processor cause a predictive model determination system (101) to perform operation comprising:
receiving a plurality of entity data (201) from a plurality of data sources (103) associated with an enterprise (102);
determining a plurality of static variables (203) from the plurality of entity data (201) based on pre-defined metadata;
computing a plurality of dynamic variables (205), for pre-determined time frames, from the plurality of entity data (201) based on the pre-defined metadata and timing window data;
creating a data model (207) based on a relationship between the plurality of static variables (203) and the plurality of dynamic variables (205);
modifying length of the pre-determined time frames of each of the plurality of dynamic variables (205) based on change in historic values of the corresponding plurality of dynamic variables (205), wherein the data model (207) is updated using the plurality of dynamic variables (205) within the modified length of the pre-determined time frames;
determining one or more predicting variables (209) by analysing the plurality of static variables (203) and the plurality of dynamic variables (205) of the updated data model (207);
forming a plurality of clusters of predicting variables (209) based on one or more common features of the plurality of predicting variables (209), wherein the data model (207) is reupdated with a clustering schema identified from the one or more common features;
identifying a plurality of predictive models for each of the plurality of clusters based on the reupdated data model (207); and
determining a predictive model (213) from the plurality of predictive models for each of the plurality of clusters, based on a score assigned to each of the plurality of clusters, for estimating a target output.

18. The medium as claimed in claim 17, wherein the plurality of entity data (201) comprises customer related information, organization related information, product related data, campaign related data, Point of Sale (POS) data and transaction information associated with customers.

19. The medium as claimed in claim 17, wherein the relationship between the static and dynamic variables is determined based on a pre-stored relationship rule.

20. The medium as claimed in claim 17, wherein the plurality of predicting variables (209) are identified using regression technique.

21. The medium as claimed in claim 17, wherein the one or more common features of the plurality of predicting variables (209) comprises patterns, attributes and value range.

22. The medium as claimed in claim 17, wherein the score to the plurality of clusters is assigned by computing a discrepancy between an observed target outcome and a predicted outcome of the predictive model (213).

23. The medium as claimed in claim 17, wherein the predictive model (213) for each of the plurality of clusters is determined based on statistical measurements.

24. The medium as claimed in claimed 17, wherein the plurality of clusters is determined using segmentation technique.
